(19) United States
(12) Patent Application Publication
(10) Pub. No.: US 2023/0036507 A1
(43) Pub. Date: Feb. 2, 2023

(54) FIRE FOUNTAIN

(71) Applicant: Paul Davis, St. Thomas, VI (US)

(72) Inventor: Paul Davis, St. Thomas, VI (US)

(21) Appl. No.: 17/390,996

(22) Filed: Aug. 1, 2021

(51) Int. Cl. A62C 3/02; A62C 37/40

(52) U.S. Cl. CPC A62C 3/0214; A62C 3/0271; A62C 37/40

(57) ABSTRACT

An illustrated view of an exemplary fire fountain for preventing a home from perishing during a fire is presented. The fire fountain is useful for providing protection for rural homes and during forest fires for rural homes that are in danger of being emblazed in a fire before firefighters can provide assistance at the home. Also, the fire fountain is useful for providing peace of mind to the rural homeowner. The fire fountain is cost effective and cost efficient while being in a constant state of readiness. The fire fountain is useful for reducing a chance of a fire and therefore saves lives and property which in turn can reduce insurance costs.

### FIELD OF THE INVENTION

This invention relates to fire prevention. More particularly, it relates to protection of a house in close locale to a forest fire.

### BACKGROUND

A wildfire, bushfire, wildland fire or rural fire k an unplanned, unwanted, uncontrolled fire in an area of combustible vegetation starting in rural areas and urban areas, Depending on the type of vegetation present, a wildfire can also be classified more specifically as a forest fire, brush fire, desert fire, grass fire, hill fire, peat fire, prairie fire, vegetation fire, or veld fire. Many organizations consider wildfire to mean an unplanned and unwanted fire, while wildland-fire k a broader term that includes prescribed fire as well as wildland fire use (WFU; these are also called monitored response fires).

Fossil charcoal indicates that wildfires began soon after the appearance of terrestrial plants 420 million years ago. The occurrence of wildfires throughout the history of terrestrial life invites conjectures that fire must have had pronounced evolutionary effects on most ecosystems' flora and fauna. Earth is an intrinsically flammable planet owing to its cover of carbon-rich vegetation, seasonally dry climates, atmospheric oxygen, and widespread lightning and volcanic ignitions.

Wildfires can be characterized in terms of the cause of ignition, their physical properties, the combustible material present, and the effect of weather on the fire. Wildfires can cause damage to property and human life, although naturally occurring wildfires may have beneficial effects on native vegetation, animals, and ecosystems that have evolved with fire. Wildfire behavior and severity result from a combination of factors such as available fuels, physical setting, and weather. Analyses of historical meteorological data and national fire records in western North America show the primacy of climate in driving large regional fires via wet periods that create substantial fuels, or drought and warming that extend conducive fire weather.

High-severity wildfire creates complex early seral forest habitat (also called “snag forest habitat”), which often has higher species richness and diversity than an unburned old forest. Many plant species depend on the effects of fire for growth and reproduction. Wildfires in ecosystems where wildfire is uncommon or where non native vegetation has encroached may have strongly negative ecological effects.

Fires in California will have ravaged more than 1.5 million hectares over 2020. That statistic is widely trumpeted as evidence of the state's worst fire season ever. A better marker of why 2020 is a tragic year (and one for the record books) is the thousands of homes destroyed and scores of lives lost.

Fires can be detrimental, ecologically or economically beneficial, or a combination. It is not uncommon for hundreds or thousands of homes and livelihoods being destroyed by fire. Many abandon their homes; the home then is defenseless against the ravaging forest fires. Other stay behind, either waiting for the firefighters to arrive or by trying to pour thousands of gallons of water on their house through a hose. These methods are most often are ineffective again forest fires destroying their homes. Firefighters are busy fighting and trying to control the forest fire, where pouring water on the home is even more risky and seldom is successful. Homes, lives and memorabilia are lost at an extraordinary rate.

Accordingly, and in light of the foregoing, it would be desirable to devise a device to protect a house by providing a large amount of water to overcome and survive a fire. It would be further advantageous if the device were automatic, cost efficient and easy to use.

### BRIEF DESCRIPTION OF THE DRAWINGS

FIG. 1 is an illustrated view of an exemplary fire fountain.

FIG. 2 is an illustrated first view of a water spray of the fire fountain shown in FIG. 1.

FIG. 3 is an illustrated view of a second water spray of the fire fountain shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

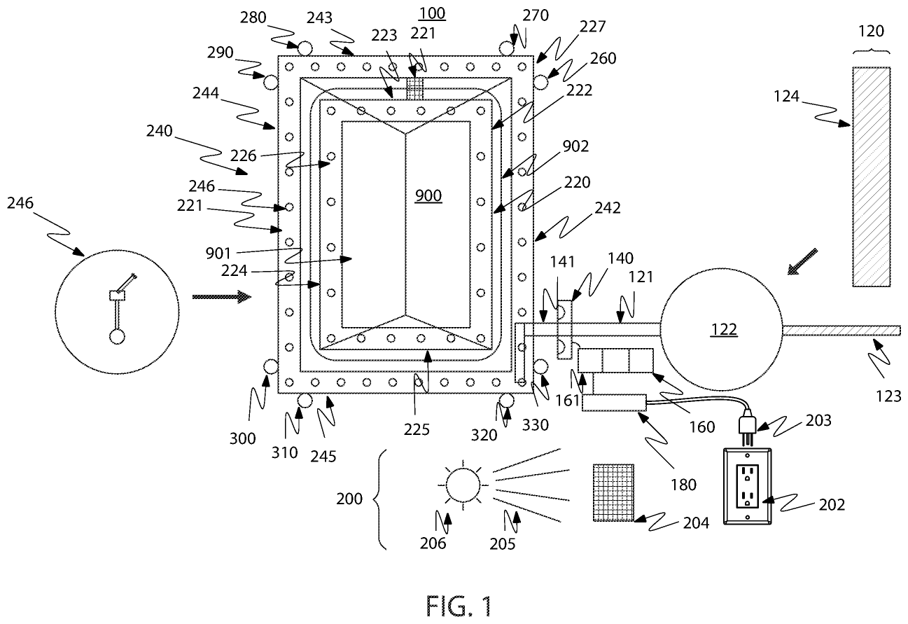

Referring to FIG. 1, an illustrated view of an exemplary fire fountain 100 for preventing a home 900 from perishing during a forest fire is presented. The fire fountain 100 is useful for providing protection for rural homes and during forest fires for rural homes that are in danger of being emblazed in a fire before firefighters can provide assistance at the home 900. Also, the fire fountain 100 is useful for providing peace of mind to the rural homeowner. The fire fountain 100 is cost effective and cost efficient while being in a constant state of readiness. The fire fountain 100 is useful for reducing a chance of a fire and therefore saves lives and property which in turn can reduce insurance costs.

The fire fountain 100 has a water source 120, a water pump 140, a plurality of batteries 160, a battery charger 180, a power source 200, a ground piping system 220, a roof piping system 240 and a plurality of heat sensors 260, 270, 280, 290, 300, 310, 320, 330.

The water source 120 is preferably a stream 124, however other types of water sources are hereby contemplated, including, but not limited to, municipal water 123, pond, pool, etc. The water source 120 is coupled to a tank 122, to reserve a quantity of water for the fire fountain 100.

The tank 122 may receive water from the water source 120, such that an ample supply of water is readily available or from one or more gutters, municipal water supply, water delivery or any combination of the foregoing. The tank 122 is preferably constructed of a fiberglass material, however other materials are hereby contemplated, including, but not limited to, steel, aluminum, concrete, etc. The tank 122 is preferably underground, however it is hereby contemplated that the tank 122 is partially or fully above ground. The tank 122 preferably has a capacity of five thousand (5000) gallons although any other capacity is hereby contemplated. Therefore, the water tank 120 shall provide two-thousand five hundred (2,500) gallons per hour for a minimum of one and one-half hours to equate to at least the tank 122 having a capacity of 5000 gallons.

The tank 122 is coupled to the water pump 140 by a first water pipe 121. The water pump 140 preferably provides a constant water pressure of seventy (70) pounds, however other constant water pressures are hereby contemplated.

The water pump 140 is coupled to the batteries 160 preferably via an inverter 161 to convert the direct current to alternating current (DC— AC), however the water pump 140 may optionally receive direct current and thus the inverter 161 would be unnecessary. The inverter 161 preferably is a 12V to 120V inverter however it is hereby contemplated that the inverter may be a 24V to 240V inverter.

The batteries 160 are further coupled to the battery charger 180. The battery charger 180 receives electrical current from the power source 200. The power source 200 is preferably AC received from a house electrical connection 202 via an electrical cord 203, however it is also contemplated that the power source 200 may be a solar panel 204. The solar panel 204 would convert energy 205 received from a sun 206 to electrical energy.

The water pump 140 is coupled to the ground piping system 220 by a second water pipe 141. The ground piping system 220 is preferably contained underground, where a top 221 of the ground piping system 220 is at ground level.

The ground piping system 220 has a first ground pipe 222, a second ground pipe 223, a third ground pipe 224 and a fourth ground pipe 225. Each of the ground pipes 222, 223, 224, 225 are coupled together to form a desired shape. The ground piping system 220 is preferably a rectangular shape, however other shapes are hereby contemplated, including, but not limited to, square, round hexagonal, “L” shape, etc.

The ground piping system 220 is preferably made of a galvanized steel material, however other materials are hereby contemplated, including, aluminum, fiberglass, poly-vinyl chloride (PVC), etc.

A plurality of spray fixtures 226 are coupled to the top 221 of the ground piping system 220. The spray fixtures 226 are preferably heavy-duty jet spray fixtures, however any other type of spray fixture desired is hereby contemplated. The spray fixtures 226 provide a high velocity stream of water that reaches any and all areas surrounding the home 900.

The roof piping system 240 is coupled to the ground piping system 220 by a third water pipe 241. The roof piping system 240 is preferably coupled to an outer edge 902 of a roof 901 of the home 900, where a top 246 of the roof piping system 240 is level with the roof 901 of the home 900.

The roof piping system 240 has a first roof pipe 242, a second roof pipe 243, a third roof pipe 244 and a fourth roof pipe 245. Each of the first roof pipe 242, second roof pipe 243, third roof pipe 244 and fourth roof pipe 245 are coupled together to form a desired shape. The roof piping system 240 is preferably a rectangular shape, however other shapes are hereby contemplated, including, but not limited to, square, round hexagonal, “L” shape, etc.

The plurality of spray fixtures 226 are coupled to the top 246 of the roof piping system 240. The spray fixtures 226 are preferably heavy-duty jet spray fixtures, however any other type of spray fixture desired is hereby contemplated. The spray fixtures 226 provide a high velocity stream of water that reaches any and all areas from the roof 901 of the home 900.

The roof piping system 240 is preferably made of a galvanized steel material, however other materials are hereby contemplated, including, aluminum, fiberglass, poly-vinyl chloride (PVC), etc.

A plurality of heat sensors 260, 270, 280, 290, 300, 310, 320, 330 are coupled to an outside 247 of the roof piping system 240 at desired locations. The heat sensors 260, 270, 280, 290, 300, 310, 320, 330 sense a temperature and transmit the sensed temperature to the water pump 120. The water pump 120 determines if the sensed temperature exceed a predetermined threshold and if it does exceed the predetermined threshold, then the water pump 120 is activated to provide high pressured water to the ground piping system 220 and the roof piping system 240.

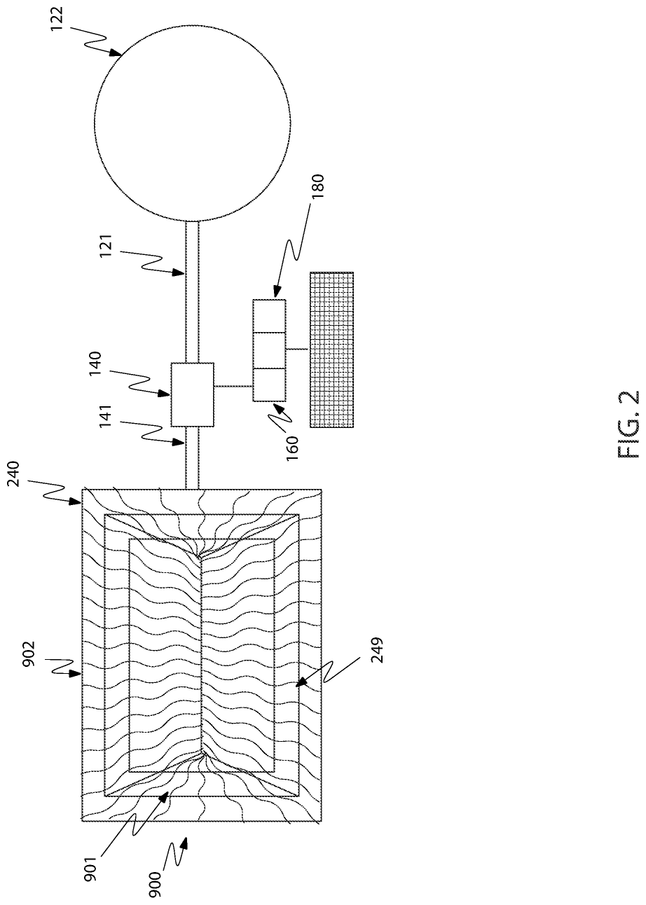

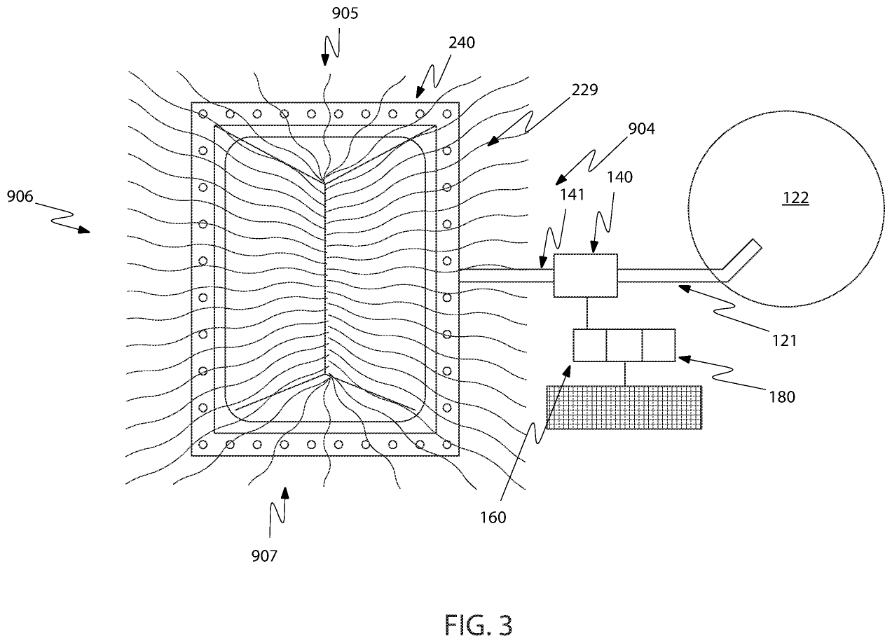

Moving now to FIG. 2 and FIG. 3, illustrated views of a spray of water 229, 249 of the fire fountain 100 is presented. FIG. 2 and FIG. 3 are similar in many aspects as the fire fountain 100 shown in FIG. 1, however the different aspects and configuration will be highlighted as alternative configurations.

The tank 122 has been filled with water and is coupled to the water pump 140 by the first water pipe 121 is presented. The water pump 140 is coupled to the inverter 161 and the batteries 160 to power the water pump 140. The water pump 140 creates pressured water to flow through the second water pipe 141 to the roof piping system 240 (FIG. 2) and the ground piping system 220 of FIG. 1 (not shown in FIG. 3)

FIG. 2 is an illustrated view of the water spray 249 from the fire fountain 100 shown in FIG. 1 is presented. The water spray 249 emanates from the roof piping system 240. The spray 249 is consistent and strong over the roof 901 of the house 900.

FIG. 3 is an illustrated view of the water spray 229 from the fire fountain 100 shown in FIG. 1 is presented. The water spray 229 emanates from the ground piping system 220. The spray 229 is consistent and strong over the roof 901 of the house 900 and to all sides 904, 905, 906, 907 of the house 900.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A fire fountain for preventing a home from perishing during a fire, the fire fountain comprising:
a water tank, the water tank coupled to a water source to receive water;
a water pump, the water pump coupled to the water tank by a first water pipe; the water pump coupled to an inverter, the inverter being coupled to a plurality of batteries;
a battery charger, the battery charger coupled to the batteries, the battery charger coupled to a power source;
a ground piping system, the ground piping system having a plurality of sides, the ground piping system coupled to the water pump by a second water pipe, the plurality of sides having a plurality of spray nozzles, wherein each of the sides configured to form a shape;
a roof piping system, the roof piping system having a plurality of sides, the roof piping system coupled to the ground piping system by a third water pipe, the plurality of sides having a plurality of spray nozzles, wherein each of the sides configured to form a shape; and
a plurality of heat sensors, the heat sensors being coupled to the roof piping system at a predetermined location, and wherein the heat sensors coupled to the water pump, the heat sensors detecting a heat and providing said heat detection to the water pump, wherein the water pump is activated when the heat detection exceeds a predetermined temperature.

2. The fire fountain of claim 1, wherein each of the sides of the ground piping system being made of a galvanized steel material.

3. The fire fountain of claim 1, wherein each of the sides of the roof piping system being made of a galvanized steel material.

4. The fire fountain of claim 1, wherein the shape of the ground piping system being a rectangle.

5. The fire fountain of claim 1, wherein the shape of the roof piping system being a rectangle.

6. The fire fountain of claim 1, wherein the water source being municipal water.

7. The fire fountain of claim 1, wherein the invertor being a 12V to 120V converter.

8. The fire fountain of claim 1, wherein the water tank having a capacity of five thousand (5000) gallons.

9. The fire fountain of claim 1, wherein water pump having a output being two-thousand five hundred (2,500) gallons per hour.

10. The fire fountain of claim 1, wherein the power source being an electrical house electrical circuit.

11. The fire fountain of claim 1, wherein the power source being a solar energy.

12. The fire fountain of claim 1, wherein the ground protection device having a plurality of high-power sprayers.

13. The fire fountain of claim 1, wherein the roof piping system having a plurality of high-powered sprayers.

14. The fire fountain of claim 1, wherein the roof piping system being coupled near an outer edge of a roof.

15. The fire fountain of claim 1, wherein the ground piping system being underground.

16. The fire fountain of claim 1, wherein a top of the group piping system being at least at ground level.
